(19) United States
(12) Patent Application Publication
(10) Pub. No.: US 2009/0161971 A1
(43) Pub. Date: Jun. 25, 2009

(54) IMAGE FORMING APPARATUS, COMPUTER-READABLE MEDIUM AND DATA PROCESSING METHOD

(75) Inventors: Hiroshi Nogawa, Hachioji-shi (JP); Fumihito Akiyama, Yokohama-shi (JP); Yoshinori Tanaka, Koganei-shi (JP); Masahiro Ozawa, Hino-shi (JP); Jun Kuroki, Sagamihara-shi (JP); Yasufumi Aoyama, Hachioji-shi (JP); Kunikazu Satou, Chofu-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/342,530

(22) Filed: Dec. 23, 2008

(30) Foreign Application Priority Data
Dec. 25, 2007 (JP) 2007-332558

(51) Int. Cl. G06F 3/12; G06K 9/36

(52) U.S. Cl. 382/232; 358/1.15

(57) ABSTRACT

Disclosed is an image forming apparatus to form an image based on an XPS file including, a storage section; and a control section to refer to information concerning usage frequency of each individual file stored in the XPS file to judge whether or not a data decompression on the individual file needs to be performed and to perform or not to perform the data decompression on the individual file according to a judgment result to store the individual file in the storage section.

### CROSS-REFERENCE TO RELATED APPLICATIONS

The present U.S. Patent Application claims priority under the Paris Convention of Japanese Patent Application No. 2007-332558 filed on Dec. 25, 2007 to the Japanese Patent Office, which shall be a basis for correcting mistranslations.

### BACKGROUND

1. Field of the Invention

The present invention relates to an image forming apparatus, computer-readable medium and data processing method.

2. Description of Related Art

In recent years, an image forming system in which a data processing apparatus such as a personal computer (PC) with a printer driver installed controls an image forming apparatus through a communication network such as a local area network (LAN), has become widely used.

Moreover, Microsoft Corporation announced an electronic document standard called an extensible markup language (XML) paper specification (XPS) standard at the end of 2006. A file of an electronic document in conformity to the XPS standard (hereinafter referred to as an XPS file) includes font data, image data, text data, and the like, and is generated by performing a ZIP compression of these data files (an XML file, image file, and the like). That is, an XPS file is a ZIP-compressed file.

The data processing apparatus performs the ZIP compression of an XML file and an image file to generate an XPS file, and sends the generated XPS file to the image forming apparatus. The image forming apparatus receives the XPS file, and then spools the file into a storage medium (such as a memory and a hard disk) The image forming apparatus then reads the XPS file from the storage medium and performs the ZIP decompression of the XPS file. Then, the image forming apparatus spools the file data subjected to the ZIP decompression into the storage medium again. The image forming apparatus then reads the file data subjected to the ZIP decompression from the storage medium to perform image forming processing. Here, image forming includes, forming an image on a sheet (printing), displaying an image on a screen (image display), and the like.

Incidentally, storage capacity of a storage medium is limited, and various efforts are made to use the limited storage capacity efficiently. For example, a technique is disclosed where compressed predetermined character data is stored in a ROM divided between a first character data group including a character of high usage frequency and a second character data group including a remaining character, and when power of an image forming apparatus is turned on, decompression processing is performed only on the first character data group to be stored in a RAM and later, after that, when a character specified based on a printing instruction belongs to the first character data group, the decompressed data is obtained from the RAM and expanded to image data to form an image, and when a character specified based on a printing instruction belongs to the second character group, compressed data is obtained from the ROM and after performing decompression processing, the data is expanded to image data to form an image (Japanese Patent Application Laid-Open Publication No. Hei 6-4231).

However, with the technique described above, since character of high usage frequency is preset manually, character of high usage frequency needs to be set again newly according to situation of various image forming, which is troublesome. Also, since the usage frequency is set manually, there is a possibility that error in the setting may occur.

### SUMMARY

The present invention has been made in consideration of the above problems, and it is one of main objects to efficiently use a storage medium and to ease trouble of operation by the user in an image forming apparatus to form an image based on an XPS file.

To achieve at least one of the above-mentioned objects, an image forming apparatus to form an image based on an XPS file reflecting one aspect of the present invention comprises:

a storage section; and

a control section to refer to information concerning usage frequency of each individual file stored in the XPS file to judge whether or not a data decompression on the individual file needs to be performed and to perform or not to perform the data decompression on the individual file according to a judgment result to store the individual file in the storage section.

It is preferable that the control section generates a usage frequency list showing usage frequency of each individual file based on a rels file stored in the XPS file to refer to the usage frequency list to judge whether or not the data decompression needs to be performed on the individual file.

It is preferable that the control section further refers to a free storage space of the storage section to judge whether or not the data decompression needs to be performed on the individual file.

It is preferable that the control section further refers to a data size of the individual file subjected to the data, decompression to judge whether or not the data decompression needs to be performed on the individual file.

It is preferable that the control section further refers to a data size of the individual file which has not been subjected to the data decompression to judge whether or not the data decompression needs to be performed on the individual file.

It is preferable that the control section further refers to an attribute of the individual file to judge whether or not the data decompression needs to be performed on the individual file.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a system configuration diagram of an image forming system;

FIG. 2 is a block diagram of a client terminal;

FIG. 3 is a file configuration diagram of an XPS file;

FIG. 4 is a data content of a rels file;

FIG. 5 is a block diagram showing an image forming apparatus;

FIG. 6 is a flowchart showing a sequence of processing concerning forming an image performed in an image forming apparatus;

FIG. 7 is a flowchart showing usage frequency list generation processing;

FIG. 8 is a data configuration diagram of a usage frequency list;

FIG. 9 is a flowchart showing XPS file decompression processing of a first embodiment;

FIG. 10 is a flowchart showing the individual file storage section selection processing; and

FIG. 11A and FIG. 11B are flowcharts showing XPS file decompression processing of a second embodiment.

### DETAILED DESCRIPTION OF PREFERRED EMBODIMENTS

### First Embodiment

In the following, a first embodiment of an image forming apparatus according to the present invention will be described.

### [System Configuration of Image Forming System]

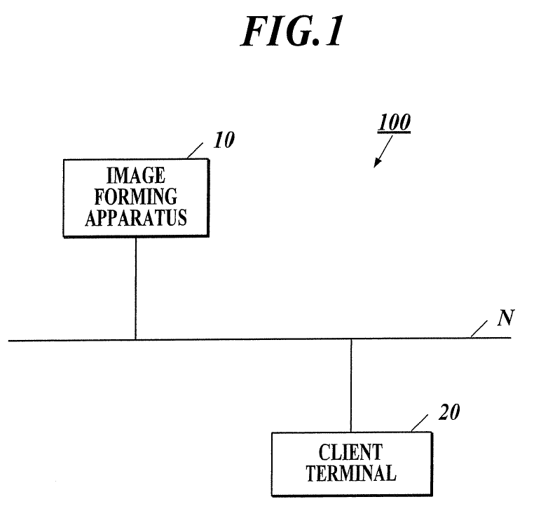

FIG. 1 shows a system configuration of an image forming system 100. As shown in FIG. 1, the image forming system 100 is composed of an image forming apparatus 10 and client terminal 20, and each apparatus is connected to each other through a communication network N in a state capable of performing data communications.

The image forming apparatus 10 is the so-called Multi-Function Peripheral (MFP) including a copy function, an image reading function, and a printer function, and forms an image on a sheet based on a print job (print instruction) sent from the client terminal 20, image data read by an image reading section, such as a scanner, provided in the image forming apparatus 10, and the like.

The client terminal 20 is the so-called personal computer, and has the function of sending a print job to the image forming apparatus 10. A printer driver program (hereinafter, sometimes simply referred to as a printer driver) is installed in the client terminal 20, and the client terminal 20 uses the function of the printer driver to generate a print job including the data of print conditions to be applied at the time of image formation, image data, and the like, and to send the generated print job to the image forming apparatus 10.

### [Functional Configuration of Client Terminal]

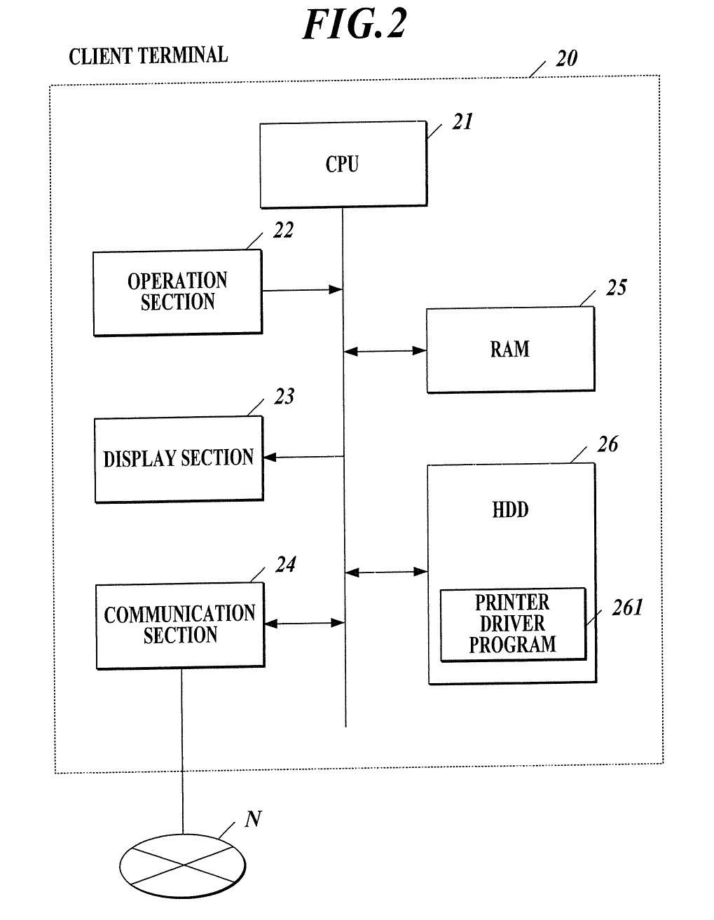

FIG. 2 shows the configuration of the client terminal 20. As shown in FIG. 2, the client terminal 20 is composed of a CPU 21, operation section 22, display section 23, communication section 24, Random Access Memory (RAM) 25, and HDD 26.

The CPU 21 reads various processing programs stored in the HDD 26 and expands the read processing programs in a work area formed in the RAM 25 to perform various kinds of control processing in cooperation with the programs according to operation signals input from the operation section 22 or instruction signals received by the communication section 24.

The operation section 22 is composed of a keyboard including cursor keys, numeral inputting keys, various function keys, and the like, and a pointing device, such as a mouse, and outputs an instruction signal input by a key operation on the keyboard or a mouse operation to the CPU 21.

The display section 23 is composed of a Liquid Crystal Display (LCD) and displays an input instruction from the operation section 22, data, and the like, according to the instruction of a display signal input from the CPU 21.

The communication section 24 includes a LAN adapter, a router, a terminal adapter (TA), and the like, and performs sending and receiving of data with external equipment such as the image forming apparatus 10 connected through the communication network N.

The RAM 25 forms a work area to temporarily store the various processing programs to be executed by the CPU 21 and the data concerning these programs.

The HDD 26 is a storage apparatus and stores various programs, setting data, image data, and the like. Moreover, the HDD 26 stores a printer driver program 261.

The CPU 21 reads the printer driver program 261 from the HDD 26 to expand the read printer driver program 261 to the RAM 25, and generates print job data to be sent to the image forming apparatus 10 in cooperation with the program 261.

Specifically, the CPU 21 specifies the image data (image file) or the like which is a print object through the operation section 22 by user operation, and sets the information concerning the number of sets, print range, and the like. The CPU 21 then performs the ZIP compression on the specified image file, etc. and generates an XPS file.

Moreover, the CPU 21 generates print condition data based on the set information concerning the number of sets, the print range, and the like.

The CPU 21 generates the print job data based on the XPS file and the print condition data to once store the generated print job data in the HDD 26.

The CPU 21 next reads the print job data from the HDD 26, and controls the communication section 24 to send the print job data to the image forming apparatus 10.

### [File Configuration of XPS File]

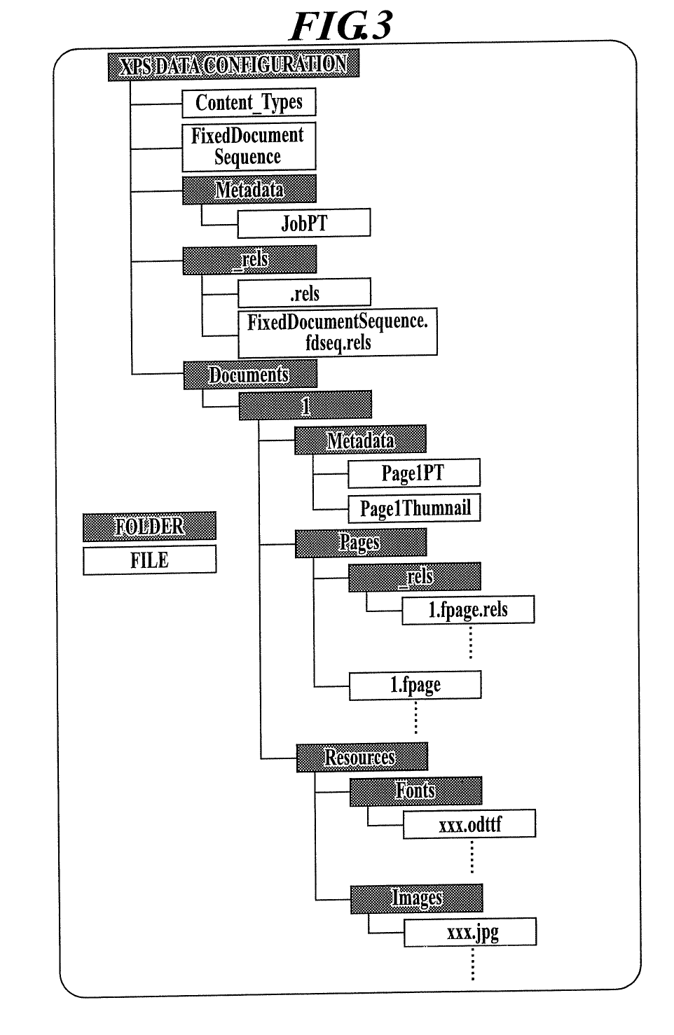

FIG. 3 shows a file configuration of the XPS file. Here, each file stored in the XPS file is generically referred as “individual file”. As shown in FIG. 3, the XPS file is configured from a group of files such as “Content_Types” file, “FixedDocumentSequence” file, “Metadata” folder, “_rels” folder, and “Documents” folder. The “Documents” folder stores individual files such as font data, image data, text data, etc. The “Documents” folder is a core folder of the XPS file.

The “_rels” folder, and “Documents” folder store one or a plurality of rels files describing a relation between pieces of data of the individual file. The “Documents” folder also stores an individual file (“l.fpage” file shown in FIG. 3) showing configuration information of a page.

### [Data Content of Rels File]

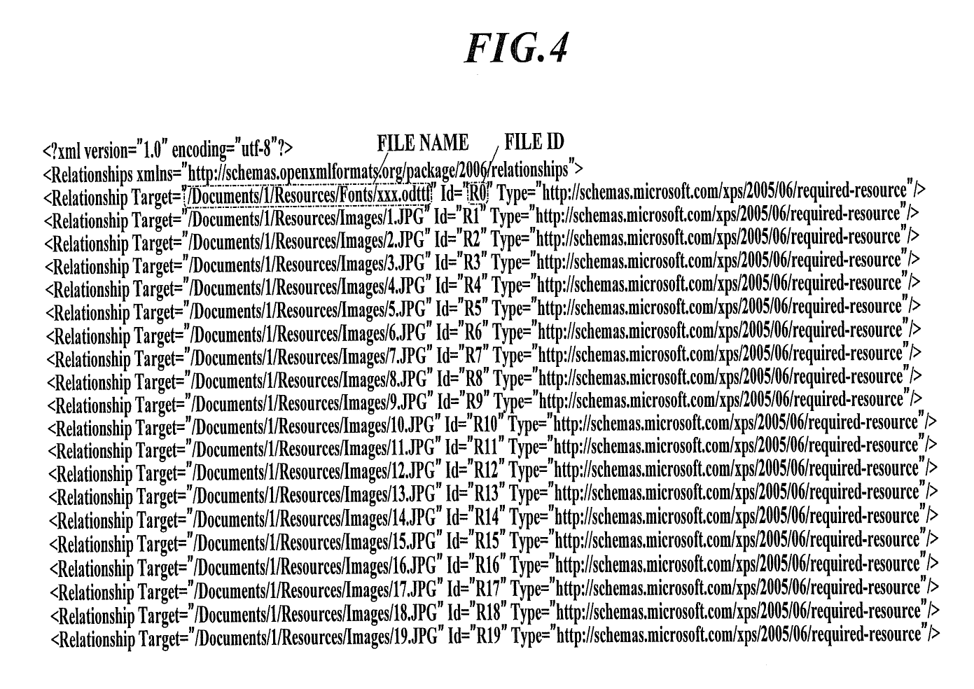

FIG. 4 shows data content of the rels file. As shown in FIG. 4, the rels file describes “file name”, “file ID”, etc. of the individual file used (referred) to form an image. Larger “number of times of description” (number of times of reference”) of a “file name” or “file ID” described in all of the rels files stored in the XPS file, means higher usage frequency (reference frequency) of the individual file corresponding to the “file name” or “file ID” in forming the image. The “file name” and “file ID” correspond to each other one to one.

### [Functional Configuration of Image Forming Apparatus]

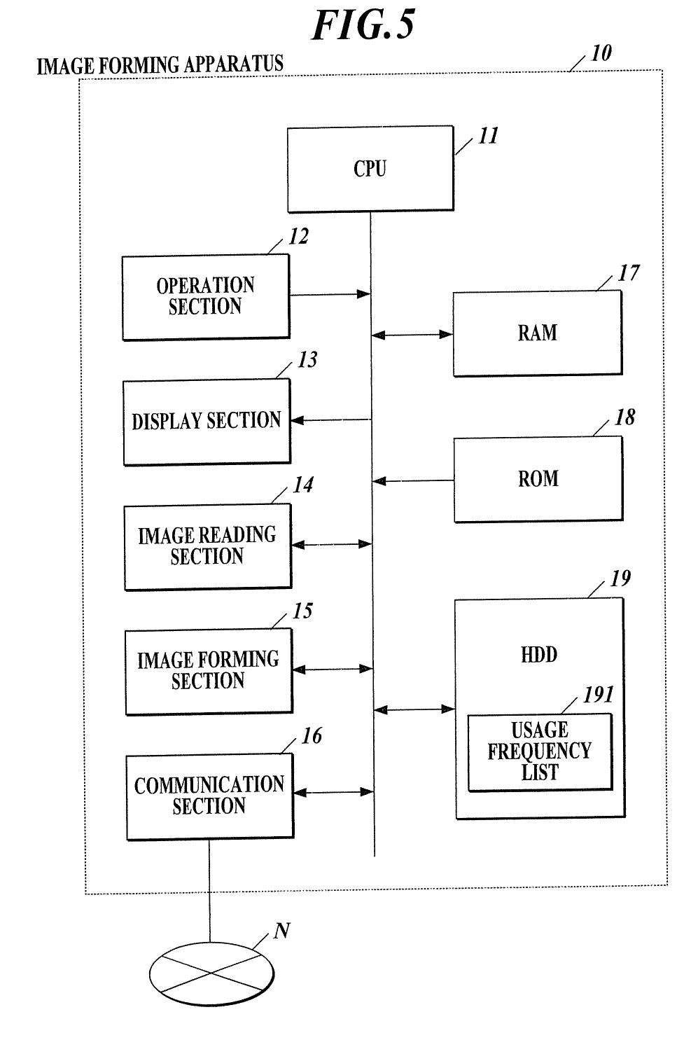

FIG. 5 shows the configuration of the image forming apparatus 10. As shown in FIG. 5, the image forming apparatus 10 is composed of a CPU 11, operation section 12, display section 13, image reading section 14, image forming section 15, communication section 16, RAM 17, Read Only Memory (ROM) 18, and HDD 19.

The CPU 11 reads the various processing programs stored in the ROM 18 and expands the read processing programs to a work area formed in the RAM 17 to perform various kinds of control processing in cooperation with the expanded programs according to operation signals input from the operation section 12 or instruction signals received by the communication section 16. For example, the CPU 11 performs a sequence of processing concerning forming the image.

The operation section 12 includes various keys, such as numeral keys, a start key, and a reset key, and outputs the depression signal of a depressed key to the CPU 11. Moreover, the operation section 12 is equipped with a touch panel integrally formed with the display section 13, and detects the position on the touch panel against which a fingertip of a user, a touch pen, or the like, touches to output a position signal to the CPU 11.

The image reading section 14 is the so-called scanner, which reads a document image to generate image data, and includes a platen glass on which a document is placed, and a scanning optical system, which scans the document image on the platen glass to form the image thereof on a CCD image sensor. The image reading section 14 performs the analog to digital (A/D) conversion of an image signal generated based on the document image read by the CCD image sensor to generate a digital image signal.

The image forming section 15 is a functional section including constituent elements necessary for forming an image by using an image forming process, such as an electrophotographic printing process, an electrostatic recording process, a thermal transfer process, etc. For example, the image forming section 15 is composed of a photosensitive body, a transfer belt, a fixing device, various conveying belts, an electronic circuit, a sheet feeding section, a sheet ejection section and the like. The image forming section 15 forms an image on a sheet supplied from the sheet feeding section based on the image data generated by the image reading section 14, the image data included in an XPS file received by the communication section 16, or the like, to convey the sheet to the sheet ejection section in accordance with an instruction of the CPU 11. Moreover, the sheet feeding section includes a sheet feeding tray, and the sheet ejection section includes a sheet ejection tray.

The communication section 16 includes a Local Area Network (LAN) adapter, a router, a Terminal Adapter (TA), and the like, and performs the sending and receiving of data with external equipment, such as the client terminal 20, connected to the communication section 16 through the communication network N. For example, the communication section 16 receives print job data from the client terminal 20.

The RAM 17 forms a work area to temporarily store the various processing programs to be performed by the CPU 11 and the data concerning these programs. Moreover, the RAM 17 stores the XPS file included in the print job data received from the client terminal 20 by the communication section 16.

The ROM 18 stores various processing programs to be performed by the CPU 11, various pieces of data, and the like. These various programs are stored in the forms of readable program codes, and the CPU 11 sequentially performs the operations in accordance with the program codes.

The HDD 19 is a storage apparatus and stores the image data read by the image reading section 14, the XPS file included in the print job data received from the client terminal 20 by the communication section 16, a usage frequency list 191 generated by the CPU 11, and the like. Moreover, the storage capacity of the HDD 19 is larger than that of the RAM 17. Moreover, the access speed of the HDD 19 from the CPU 11 is slower than that of the RAM 17.

### [Sequence of Processing Concerning Image Forming]

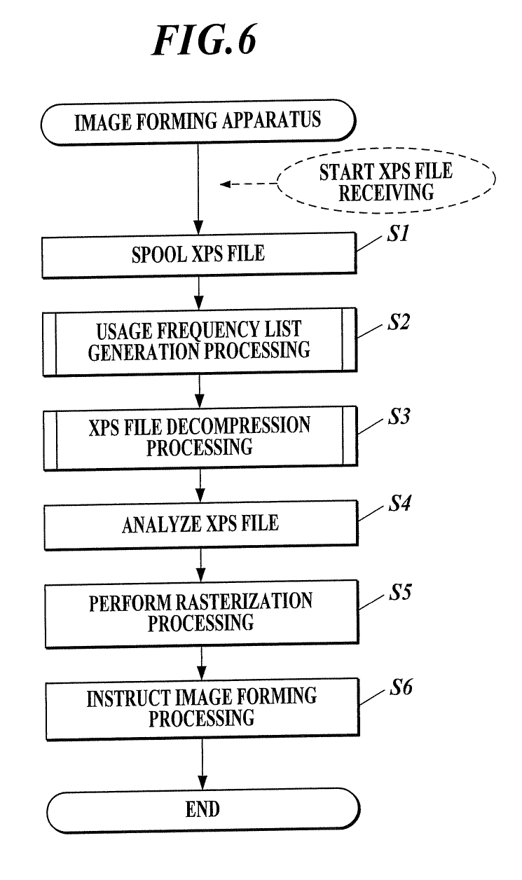

Next, specific processing content of a sequence of processing concerning the image forming performed by the CPU 11 is described with reference to FIG. 6. FIG. 6 is a flowchart showing the sequence of processing concerning image forming. The flowchart only focuses on the XPS file as data the image forming apparatus 10 receives from the client terminal 20.

First, when the communication section 16 starts receiving the XPS file from the client terminal 20, the CPU 11 stores (spools) the XPS file in the RAM 17 or the HDD 19 (step S1).

Next, the CPU 11 performs usage frequency list generation processing (step S2). The usage frequency list generation processing is a processing where the CPU 11 generates the usage frequency list 191 showing usage frequency of each individual file stored in the XPS file based on all of the rels files stored in the XPS file received in step S1.

Then, the CPU 11 performs XPS file decompression processing (step S3). The XPS file decompression processing is a processing where the CPU 11 judges whether or not the data decompression needs to be performed on the individual file based on the usage frequency list 191 generated in step S2, and according to the judgment result, the CPU 11 performs or does not perform the ZIP decompression on the individual file to store the individual file in the RAM 17 or HDD 19.

Next, the CPU 11 reads each of the individual file from the RAM 17 or HDD 19, and based on these individual files, analyzes the XPS file (step S4) and performs rasterization processing (step S5). In the analysis of the XPS file (step S4) and rasterization processing (step S5), the CPU 11 uses the individual file subjected to ZIP decompression as it is. As for the individual file on which the ZIP decompression has not been performed, the CPU 11 performs the ZIP decompression each time the individual file is used and the decompressed data is discarded after use.

Next, the CPU 11 outputs image data, etc. to the image forming section 15 and forms an image on a sheet (step S6). With these steps, the sequence of processing concerning image forming processing ends.

### [Usage Frequency List Generation Processing]

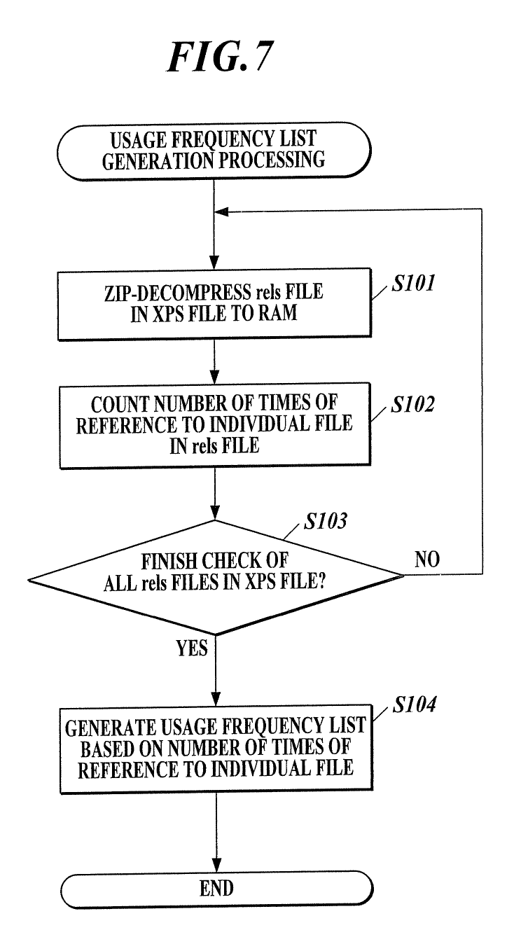

Next, the specific processing content of the usage frequency list generation processing (step S2 shown in FIG. 6) is described with reference to FIG. 7. FIG. 7 is a flowchart showing the usage frequency list generation processing.

As shown in FIG. 7, the CPU 11 extracts the rels file stored in the XPS file received from the client terminal 20 and stored in the RAM 17 or HDD 19. Then, the CPU 11 performs the ZIP decompression on the rels file and stores the file in the RAM 17 (memory) (step S101). Then, the CPU 11 counts the number of times of reference to the “file name” or the “file ID” described in the rels file, in other words, the number of times of reference to the individual file (step S102).

Next, the CPU 11 judges whether or not processing of step S101 and step S102 are performed on all of the rels files stored in the XPS file (step S103). When the CPU 11 judges step S101 and step S102 are not performed on all of the rels files stored in the XPS file (step S103; No), the CPU 11 extracts another rels file and performs the ZIP decompression on the rels file to store in the RAM 17 (step S101).

When the CPU 11 judges the processing of step S101 and step S102 are performed on all of the rels files stored in the XPS file (step S103; Yes), the CPU 11 generates the usage frequency list 191 based on the counted number of times of reference to the individual files (step S104). With these steps, the usage frequency list generation processing ends.

### [Data Configuration of Usage Frequency List]

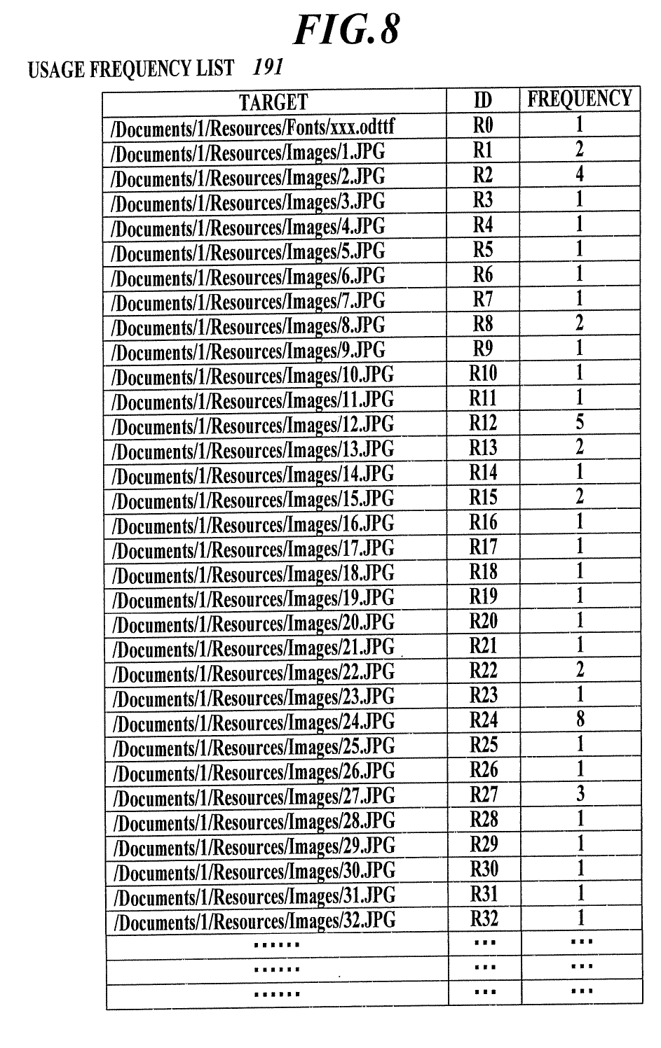

FIG. 8 shows data configuration of the usage frequency list 191. As shown in FIG. 8, the usage frequency list 191 is configured from one or a plurality of records including fields of “TARGET”, “ID”, and “FREQUENCY”.

Here, “TARGET” is a field showing file name of the individual file. The “ID” is a field showing file ID of the individual file. The “FREQUENCY” is the number of times of reference to the individual file counted by the CPU 11, and is a field showing the usage frequency of the individual file. The value of the “FREQUENCY” is the total value of number of times of description of the individual files in each rels file. In other words, in the XPS file which stores five rels files, when “file name” or “file ID” of a specific individual file A is described in three rels files, the value of the “FREQUENCY” of the field corresponding to the individual file A is “3”.

For example, according to FIG. 8, an individual file with a file name “/Documents/1/Resources/Images/8.jpg” and file ID “R8” is described (referred) a total of two times in all of the rels files stored in the XPS file.

As described above, the “file name” and “file ID” of the individual file correspond to each other one to one, therefore, the usage frequency list 191 can include only the fields “TARGET” and “FREQUENCY” or “ID” and “FREQUENCY”.

### [XPS File Decompression Processing]

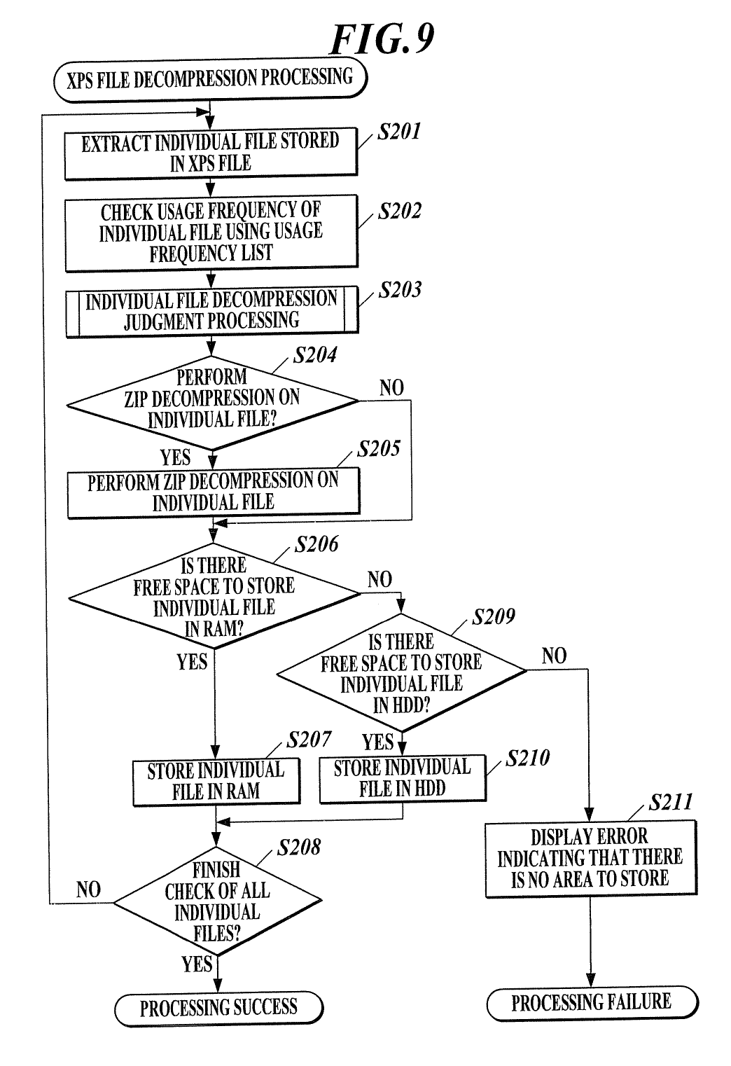

Next, the specific processing content of the XPS file decompression processing (step S3 shown in FIG. 6) is described with reference to FIG. 9. FIG. 9 is a flowchart showing the XPS file decompression processing.

As shown in FIG. 9, the CPU 11 extracts the individual file stored in the XPS file (step S201). Then, the CPU 11 refers to the usage frequency list 191 and obtains the value of the “FREQUENCY” of the record corresponding to the “file name” or “file ID” of the extracted individual file (checks the usage frequency of the individual file) (step S202).

Then, the CPU 11 performs the individual file decompression judgment processing (step S203). The individual file decompression judgment processing is a processing where the CPU 11 judges whether or not to perform the ZIP decompression on the individual file based on the usage frequency of the individual file, etc.

As a result of the individual file decompression judgment processing (step S203), when the CPU 11 judges that “the ZIP decompression is performed on the individual file” (step S204; Yes), the CPU 11 performs the ZIP decompression on the individual file extracted in step S201 (step S205). Then, the CPU 11 judges whether or not there is free storage space (free space) to store the ZIP-decompressed individual file in the RAM 17 (step S206).

On the other hand, as a result of the individual file decompression judgment processing (step S203), when the CPU 11 judges that “the ZIP decompression is not performed on the individual file” (step S204; No), the CPU 11 does not perform the ZIP decompression on the individual file extracted in step S201. Then, the CPU 11 judges whether or not there is free storage space in the RAM 17 to store the individual file (step S206).

In step S206, when the CPU 11 judges there is free storage space in the RAM 17 (step S206; Yes), the CPU 11 stores in the RAM 17 the ZIP-decompressed individual file or the individual file remaining in the ZIP-compressed state (step S207) Then, the CPU 11 judges whether or not the sequence of processing such as the extraction and decompression judgment (step S201 to step S207, step S209, step S210) have been performed on all of the individual files stored in the XPS file (step S208).

In step S206, when the CPU 11 judges there is no free storage space in the RAM 17 (step S206; No), the CPU 11 judges whether or not there is free storage space in the HDD 19 to store the ZIP-decompressed individual file or the individual file remaining in the ZIP-compressed state (step S209).

In step S209, when the CPU 11 judges there is free storage space in the HDD 19 (step S209; Yes), the CPU 11 stores in the HDD 19 the ZIP-decompressed individual file or the individual file remaining in the ZIP-compressed state (step S210) Then, the CPU 11 judges whether or not the sequence of processing such as the extraction and decompression judgment (step S201 to step S207, step S209, step S210) have been performed on all of the individual files stored in the XPS file (step S208).

In step S209, when the CPU 11 judges there is no free storage space in the HDD 19 (step S209; No), the CPU 11 displays an error display on the display section 13 indicating there is no area to store the file (step S211) and ends the XPS file decompression processing. In this case, the CPU 11 does not analyze the XPS file, perform rasterization processing, or instruct image forming processing (step S4 to step S6 shown in FIG. 6).

In step S208, when the CPU 11 judges the sequence of processing such as the extraction and decompression judgment have not been performed on all of the individual files stored in the XPS file (step S208; No), the CPU 11 extracts another individual file stored in the XPS file (step S201), and performs the sequence of processing such as decompression judgment (step S202 to step S207, step S209, step S210).

In step S208, when the CPU 11 judges the sequence of processing such as the extraction and decompression judgment have been performed on all of the individual files stored in the XPS file (step S208; Yes), the XPS file decompression processing ends.

### [Individual File Decompression Judgment Processing]

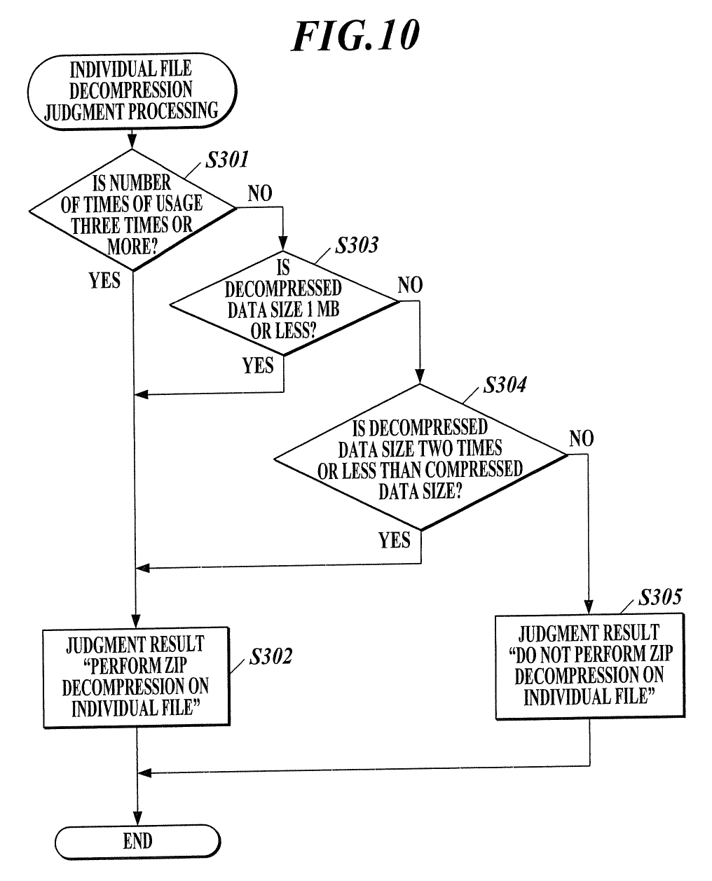

Next, the specific processing content of the individual file decompression judgment processing (step S203 shown in FIG. 9) is described with reference to FIG. 10. FIG. 10 is a flowchart showing the individual file decompression judgment processing.

As shown in FIG. 10, the CPU 11 refers to the usage frequency list 191 and judges whether or not the value of the “FREQUENCY” of the obtained individual file is “3” or more (step 301). In other words, the CPU 11 judges whether or not the number of times the individual file is used is three times or more (whether or not the total number of times of description of the individual file in each rels file is three times or more). As a result of the judgment, when the number of times the file is used is three times or more (step S301; Yes), the CPU 11 judges that “the ZIP decompression is performed on the individual file” (step S302).

As a result of the judgment in step S301, when the number of times the file is used is less than three times (step S301; No), the CPU 11 refers to the header information of the individual file, and judges whether or not the data size of the ZIP-decompressed individual file is 1 MB or less (step S303). As a result of the judgment, when the size is 1 MB or less (step S303; Yes), the CPU 11 judges that “the ZIP decompression is performed on the individual file” (step S302).

As a result of the judgment in step S303, when the data size of the ZIP-decompressed individual file is more than 1 MB (step S303; No), the CPU 11 refers to the header information of the individual file and judges whether or not the data size of the ZIP-decompressed individual file is two times or less than the data size of the ZIP-compressed individual file (step S304). As a result of the judgment, when the size is two times or less (step S304; Yes), the CPU 11 judges that “the ZIP decompression is performed on the individual file” (step S302).

As a result of the judgment in step S304, when the data size of the ZIP-decompressed individual file is more than two times the data size of the ZIP-compressed individual file (step S304; No), the CPU 11 judges that “the ZIP decompression is not performed on the individual file” (step S305).

After the CPU 11 performs the processing of step S302 or step S305, the individual file decompression judgment processing ends.

In the individual file decompression judgment processing, in addition to the number of times the individual file is used (usage frequency), the data size of the ZIP-decompressed (data-decompressed) individual file, and the data, size of the ZIP-compressed individual file (before data decompression), the CPU 11 can judge whether or not to perform the ZIP decompression on the individual file based on free storage space of the RAM 17 or HDD 19.

Tuning can be performed according to a usage pattern of the image forming apparatus 10 with the number of times the individual file is used, data size after data decompression, data size before data decompression, free storage space of the storage media, or the like as parameters.

As described above, according to the first embodiment, the CPU 11 generates the usage frequency list 191 showing usage frequency of each individual file stored in the XPS file based on all of the rels files stored in the XPS file received from the client terminal 20 by the communication section 16. Then, the CPU 11 judges whether or not the data decompression on the individual file needs to be performed based on the usage frequency list 191. Then, according to the judgment result, the CPU 11 performs or does not perform the ZIP decompression on the individual file and stores the individual file in the RAM 17 or HDD 19.

Therefore, in the image forming apparatus 10 which forms an image based on the XPS file, storage media such as RAM 17 or HDD 19 can be used efficiently. Also, even when the storage capacity of the RAM 17 is small, data can be processed without retracting the data to the HDD 19, etc., therefore the storage capacity of the RAM 17 can be used effectively and high speed processing in forming an image can be realized.

Also, the CPU 11 judges whether or not the data decompression on the individual file needs to be performed based on data size of the ZIP-decompressed (data decompressed) individual file, data size of the ZIP-compressed individual file (before data decompression), free storage space of the RAM 17 or the HDD 19, and the like, in addition to the number of times the individual file is used (usage frequency), therefore more flexible judgment of whether or not the data decompression needs to be performed is possible.

Further, the CPU 11 performs calculation of the usage frequency of the individual file based on the information stored in the XPS file, etc., therefore the user does not have to set the usage frequency.

In the present embodiment, the image forming apparatus 10 stores the individual file in either the RAM 17 or HDD 19, however, it is not limited to this. For example, the image forming apparatus 10 can further comprise another storage medium (flash memory, etc.) other than the RAM 17 and HDD 19, and the individual file can be stored in any of the at least three storage media.

In the analysis of the XPS file (step S4 shown in FIG. 6) and rasterization processing (step S5 shown in FIG. 6) according to the present embodiment, as for the individual file on which ZIP decompression has not been performed, the CPU 11 performs the ZIP decompression each time the individual file is used, and discards the decompressed data after use. Alternatively, the CPU 11 can further refer to the usage frequency list 191 and the individual file with the value “1” in the field “FREQUENCY” can be discarded with the decompressed data after use.

### Second Embodiment

In the following, a second embodiment of an image forming apparatus according to the present invention will be described. Incidentally, different point between the second embodiment and the first embodiment is the processing content of the XPS file decompression processing. In the XPS file decompression processing of the second embodiment, the CPU 11 judges whether or not the data decompression is necessary based on attribute (type of individual file such as individual file showing page configuration information, individual file of font data, etc.) of the individual file and usage frequency.

### [XPS File Decompression Processing]

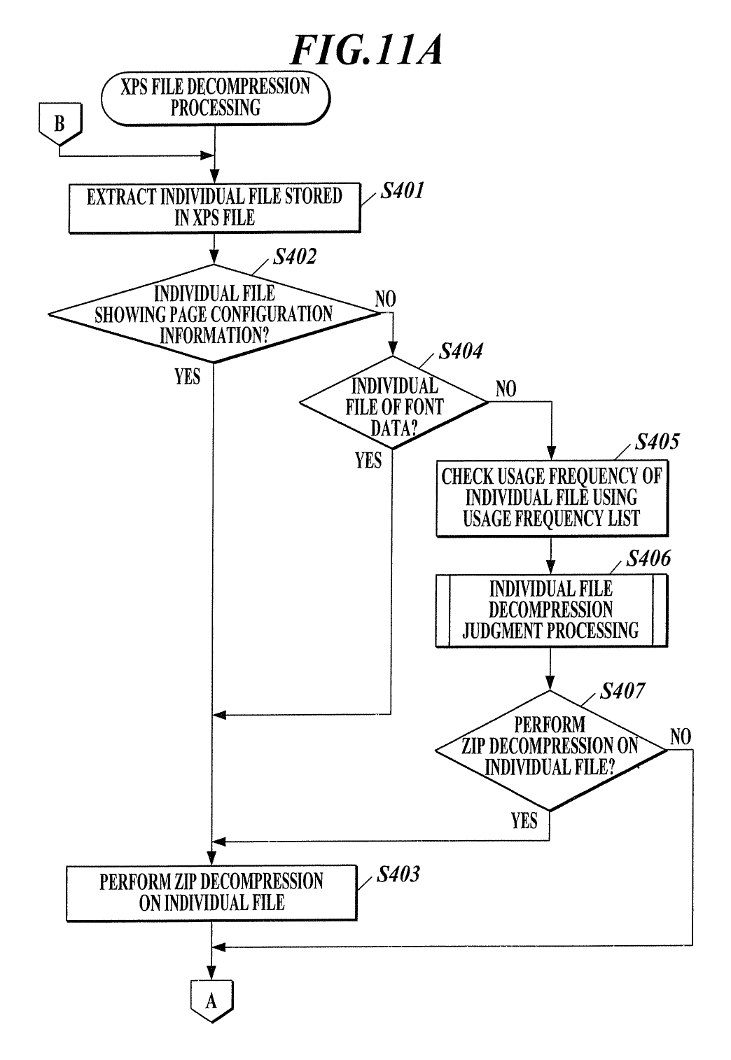

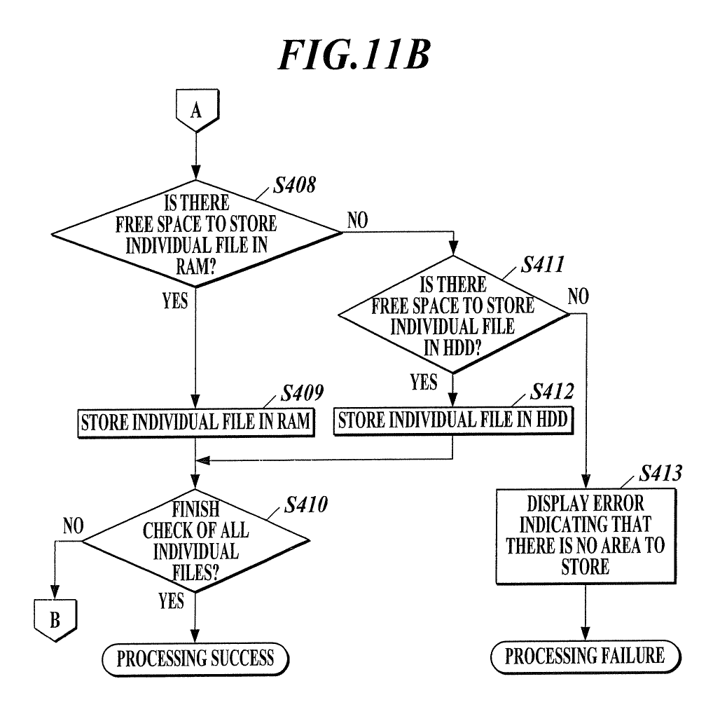

In the following, specific processing content of the XPS file decompression processing (step S3 shown in FIG. 6) is described with reference to FIG. 11A and FIG. 11B. FIG. 11A and FIG. 11B are flowcharts showing the XPS file decompression processing.

As shown in FIG. 11A and FIG. 11B, the CPU 11 extracts the individual file stored in the XPS file (step S401). Then, the CPU 11 judges whether or not the extracted individual file is the individual file showing page configuration information (step S402). As a result of the judgment, when the extracted individual file is the individual file showing page configuration information (step S402; Yes), the CPU 11 performs the ZIP decompression on the individual file (step S403). Then, the CPU 11 judges whether or not there is free storage space in the RAM 17 to store the ZIP-decompressed individual file (step S408).

As a result of the judgment in step S402, when the extracted individual file is not the individual file showing page configuration information (step S402; No), the CPU 11 judges whether or not the extracted individual file is the individual file of font data (step S404). As a result of the judgment, when the extracted individual file is the individual file of font data (step S404; Yes), the CPU 11 performs the ZIP decompression on the individual file (step S403). Then, the CPU 11 judges whether or not there is free storage space in the RAM 17 to store the ZIP-decompressed individual file (step S408).

As a result of the judgment in step S404, when the extracted individual file is not the individual file of the font data (step S404; No), the CPU 11 refers to the usage frequency list 191 and obtains the value of the “FREQUENCY” of the record corresponding to the “file name” or “file ID” of the extracted individual file (the CPU 11 checks the usage frequency of the individual file) (step S405).

Then, the CPU 11 performs the individual file decompression judgment processing (step S406). As a result of the individual file decompression judgment processing (step S406), when the CPU 11 judges that “the ZIP decompression is performed on the individual file” (step S407; Yes), the ZIP decompression is performed on the individual file (step S403). Then, the CPU 11 judges whether or not there is free storage space in the RAM 17 to store the ZIP-decompressed individual file (step S408).

On the other hand, as a result of the individual file decompression judgment processing (step S406), when the CPU 11 judges that “the ZIP decompression is not performed on the individual file” (step S407; No), the CPU 11 does not perform the ZIP decompression on the individual file. Then, the CPU 11 judges whether or not there is free storage space in the RAM 17 to store the individual file (step S408).

In step S408, when the CPU 11 judges there is free storage space in the RAM 17 (step S408; Yes), the CPU 11 stores the ZIP-decompressed individual file or the individual file remaining in the ZIP-compressed state in the RAM 17 (step S409). Then, the CPU 11 judges whether or not the sequence of processing such as the extraction and decompression judgment (step S401 to step S409, step S411, step S412) have been performed on all of the individual files stored in the XPS file (step S410).

In step S408, when the CPU 11 judges there is no free storage space in the RAM 17 (step S408; No), the CPU 11 judges whether or not there is free storage space in the HDD 19 to store the ZIP-decompressed individual file or the individual file remaining in the ZIP-compressed state (step S411).

In step S411, when the CPU 11 judges there is free storage space in the HDD 19 (step S411; Yes), the CPU 11 stores the ZIP-decompressed individual file or the individual file remaining in the ZIP-compressed state in the HDD 19 (step S412). Then, the CPU 11 judges whether or not the sequence of processing such as the extraction and decompression judgment (step S401 to S409, step S411, step S412) have been performed on all of the individual files stored in the XPS file (step S410).

In step S411, when the CPU 11 judges there is no free storage space (step S411; No), the CPU 11 displays on the display section 13 an error display indicating there is no area to store the file (step S413) and the XPS file decompression processing ends. In this case, the CPU 11 does not analyze the XPS file, perform rasterization processing or instruct image forming processing (step S4 to step S6 shown in FIG. 6).

In step S410, when the CPU 11 judges the sequence of processing such as the extraction and decompression judgment have not been performed on all of the individual files stored in the XPS file (step S410; No), the CPU 11 extracts another individual file stored in the XPS file (step S401), and performs the sequence of processing such as decompression judgment (step S402 to step S409, step S411, step S412).

In step S410, when the CPU 11 judges the sequence of processing such as the extraction and decompression judgment have been performed on all of the individual files stored in the XPS file (step S410; Yes), the XPS file decompression processing ends.

As described above, according to the second embodiment, in the XPS file decompression processing, the CPU 11 performs the ZIP decompression on the individual file with certain attribute (individual file showing page configuration information, individual file of font data, etc.) without performing individual file decompression judgment processing. Therefore, more flexible judgment of whether or not the data decompression needs to be performed on the individual file is possible.

The above-described embodiment discloses an example using the ROM and HDD as computer-readable media to store the program, however the present invention is not limited to this example. As other computer-readable media, nonvolatile memory such as flash memory, portable storage medium such as a CD-ROM can be used. As a medium to provide program data through the communication line, a carrier wave can be used.

What is claimed is:

1. An image forming apparatus to form an image based on an XPS file comprising:
a storage section; and
a control section to refer to information concerning usage frequency of each individual file stored in the XPS file to judge whether or not a data decompression on the individual file needs to be performed and to perform or not to perform the data decompression on the individual file according to a judgment result to store the individual file in the storage section.

2. The image forming apparatus of claim 1, wherein the control section generates a usage frequency list showing usage frequency of each individual file based on a rels file stored in the XPS file to refer to the usage frequency list to judge whether or not the data decompression needs to be performed on the individual file.

3. The image forming apparatus of claim 1, wherein the control section further refers to a free storage space of the storage section to judge whether or not the data decompression needs to be performed on the individual file.

4. The image forming apparatus of claim 1, wherein the control section further refers to a data size of the individual file subjected to the data decompression to judge whether or not the data decompression needs to be performed on the individual file.

5. The image forming apparatus of claim 1, wherein the control section further refers to a, data size of the individual file which has not been subjected to the data decompression to judge whether or not the data decompression needs to be performed on the individual file.

6. The image forming apparatus of claim 1, wherein the control section further refers to an attribute of the individual file to judge whether or not the data decompression needs to be performed on the individual file.

7. A computer-readable medium embodying a program to allow a computer which forms an image based on an XPS file to function as:
a storage section; and
a control section to refer to information concerning usage frequency of each individual file stored in the XPS file to judge whether or not a data decompression on the individual file needs to be performed and to perform or not to perform the data decompression on the individual file according to a judgment result to store the individual file in the storage section.

8. A data processing method comprising:
referring to information concerning usage frequency of each individual file stored in the XPS file;
judging whether or not a data decompression on the individual file needs to be performed;
performing or not performing the data decompression on the individual file according to a judgment result; and
storing the individual file in the storage section.
